(19) United States
(12) Patent Application Publication
(10) Pub. No.: US 2008/0168756 A1
(43) Pub. Date: Jul. 17, 2008

(54) Cutting assembly with high lift impeller blade and string trimmer combination

(76) Inventor: Dean Nafziger, Archbold, OH (US)

Correspondence Address: EMCH, SCHAFFER, SCHAUB & PORCELLO CO, P O BOX 916, ONE SEAGATE SUITE 1980, TOLEDO, OH, 43697, US

(21) Appl. No.: 12/077,427

(22) Filed: Mar. 17, 2008

Related U.S. Application Data
(63) Continuation of application No. 11/359,633, filed on Feb. 21, 2006.

(51) Int. Cl. A01D 34/416; A01D 75/18

(52) U.S. Cl. 56/10.4; 56/13.7

(57) ABSTRACT

This apparatus is a cutting assembly commonly used as a trimmer with a mower deck combination but not limited to such a combination. This trimmer head assembly utilizes a high lift mower blade in combination with a string or line trimming blade in a housing which creates a vortex of air which draws grass and weeds toward the assembly where they may be cut with the rotating line. By drawing grass and weeds towards the assembly and away from obstructions this cutting assembly results in a closer cut than may be achieved with a conventional trimmer. Because grass and weeds are drawn away from obstructions and cut, the trimming string does not make contact with obstructions and therefore causes no damage to objects such as gravestones, fences, etc. This cutting assembly may be adapted for use on a variety of lawn and grounds keeping equipment such as hand held string trimmers, walk behind trimmers, or in place of a normal mowing assemblies on riding or push lawnmowers.

### BACKGROUND OF THE INVENTION

This invention is an improved cutting assembly for trimming grass and weeds around obstructions such as fences, gravestones and other objects. This trimmer utilizes a high lift impeller mowing blade in combination with a string trimming head to create a vortex-type flow of air within a housing, that draws grass and weeds toward the cutting assembly and away from obstructions, thereby allowing for a clean, close cut around the obstructions.

Conventional lawn mowers, be they walk behind, lawn tractors and riders of all types, have long had the disadvantage of an inability to closely trim or edge around stationary objects such as trees, posts, buildings and the like. Commonly, the trimming and edging is accomplished by hand, using a string trimmer or trimming mower. Such hand edging is time consuming and physically demanding.

Particularly troublesome areas to mow are found in cemeteries. When mowing a cemetery, one has to mow around a multitude of permanent grave stones without damaging the stones. Typically, the job is completed with a string trimmer by hand. Stone placement and size differ throughout cemeteries thus creating a great deal of hand labor to properly mow and trim a cemetery.

A mower and trimmer combination is disclosed in my U.S. Pat. No. 6,546,706, issued Apr. 15, 2003 and also in my U.S. Pat. No. 6,786,030, issued Sep. 7, 2004. This invention improves upon the trimmer design by combining a specially designed housing with a high lift mowing blade and a string trimmer head which allows for more efficient trimming. In addition to incorporating the high lift blade and string trimmer head, this invention improves upon known prior art trimmers in that it is designed to utilize a vacuuming or suctioning air flow that draws blades of grass or weeds inward toward the housing, away from obstructions. This vacuuming action is created by the rotating high lift blade which is located in the interior of the housing and acts as an impeller. Once drawn to the cutting assembly, the grass is cut by the string trimmer lines and the clippings are drawn inwards into the housing dropping back on the center of the high lift blade to be recut. The inward flow of air and clippings is achieved by combining the impeller action of the high lift mower blade and the curved design of the housing. By combining this vacuuming action, a high lift blade and a string trimmer, this invention improves upon the prior art by providing closer trimming results while minimizing time and effort in operation and reducing the risk of any damage to the obstructions.

Although the cutting assembly described herein is incorporated into an attachment on a riding mower mower deck, such as that shown in my '030 patent, the basic design of an assembly combining a high lift blade and string trimmer head within a housing may be adapted for use on a variety of lawn and grounds keeping equipment such as hand held string trimmers, walk behind trimmers and mowers, or in place of a normal mowing assemblies on riding or push lawnmowers.

### BRIEF DESCRIPTION OF THE DRAWINGS

FIG. 1 shows the cutting assembly of the present invention in combination with a mowing deck.

FIG. 2 is a bottom view of the cutting assembly of FIG. 1 showing the high-lift blade and string trimmer head.

FIG. 3 is a side view cross section of the cutting assembly of FIG. 2.

FIG. 4 is a schematic illustration of the vacuuming over flow and cutting action of the present invention in operation.

### DETAILED DESCRIPTION OF THE PREFERRED EMBODIMENT(S)

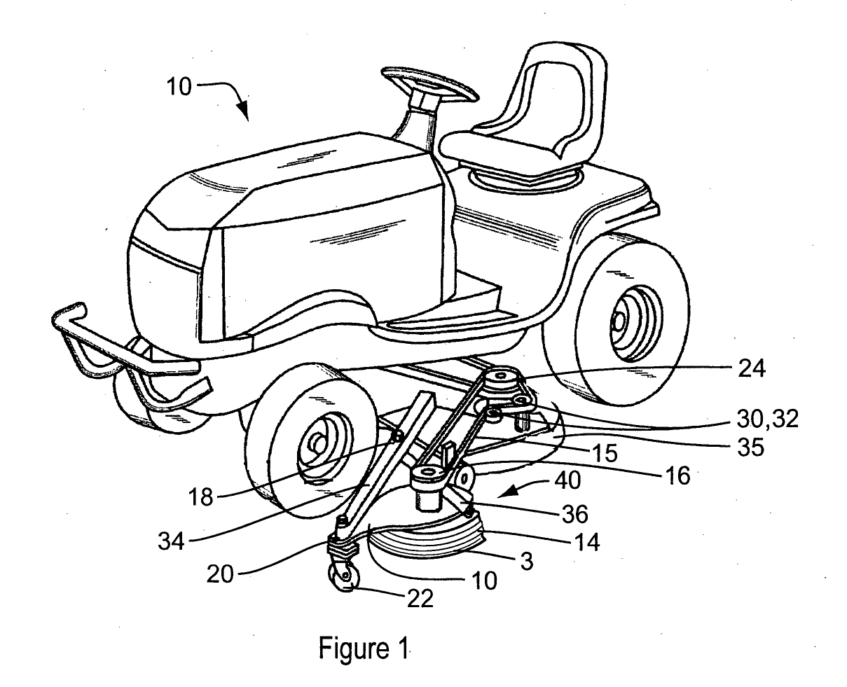

FIG. 1 shows the cutting assembly of the present invention, incorporated into the trimmer and deck combination of my '030 patent. For the purposes of illustration, the structures described in my '030 patent are described herein. Those structures, however, are not intended to limit the various uses to which the cutting assembly of this invention can be adapted.

FIG. 1 shows a conventional tractor 10 with a mower deck 35 attached thereto. An arm 34 connects the cutting assembly 40 to the mower deck 35. The arm 34 is bolted 18 to the mower deck 35 to allow for easy removal. A pivot mechanism or connector 20 connects the arm 34 to the cutting assembly 40. The cutting assembly 40 is maintained in an orientation that is forward and to one side of the mower deck 35. The pivot connector 20 defines a fixed pivot axis normal to the cutting plane of the mower deck 35. A wheel 22 is fixed to the arm 34 to provide stability for the cutting assembly 40. Resilient arm 36 engages the arm 34 and the cutting assembly 40 to assist in providing horizontal stability to the cutting assembly. In other configurations such as on a hand held trimmer the drive assembly may be directly connected to the main shaft of the unit.

The assembly is driven by a belt 28 which in turn is driven by drive pulley 24 and trimmer pulley 16. Belt 28 tension is maintained by the idler pulleys 30 and 32 which allow the belt 28 to move inwardly and outwardly to compensate for the movement of the trimmer head 40. The cutting assembly 40 includes a traction device or bumper 14, such as a belt mounted for movement on the housing 3 or the housing 3 being mounted on bearings to rotate about the cutting blade shaft is shown generally.

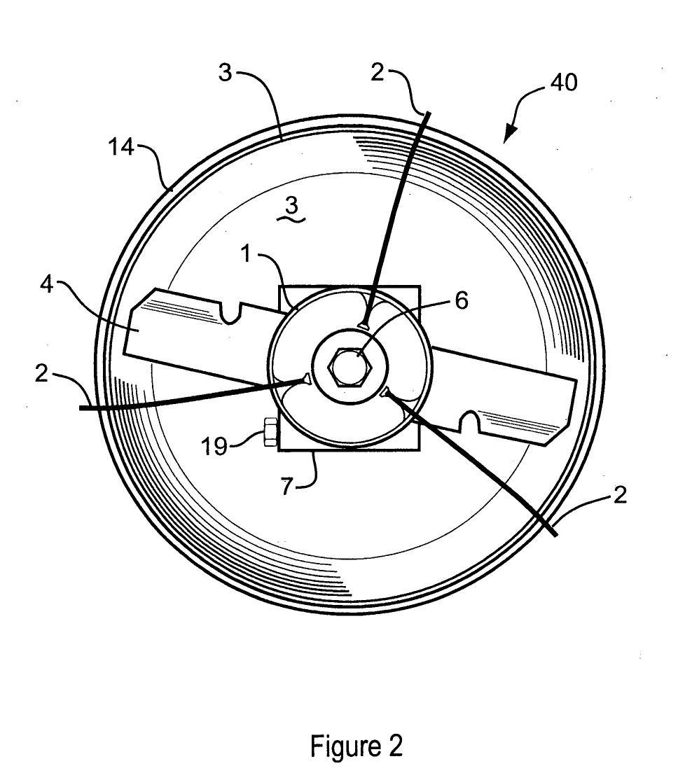

FIG. 2 is a bottom view of the cutting assembly and housing of the present invention showing the high-lift blade and string trimmer head. The housing 3 depicted in the figures is a rotating housing. It should be noted, however, that the housing of the present invention need not be limited to a rotating housing. It can for instance be a fixed housing. The rotating housing 3 includes a bumper member 14 which provides a cushion between the housing and any obstructions, thereby minimizing any damage caused by contact between the housing and the obstruction. The bumper may be constructed of any resilient cushioning material. The bumper 14 extends outward farther than any part of the housing, thereby making it the first point of contact with any obstructions.

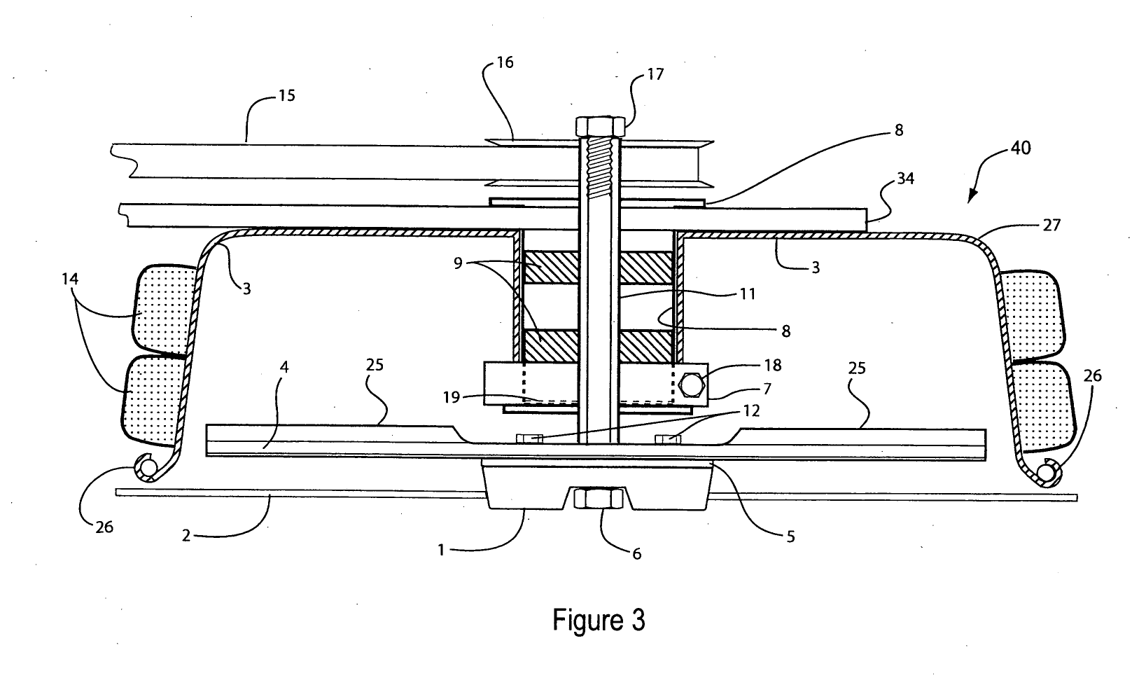

A string or line trimming assembly is made up of a string head 1 and the trimming strings 2. The string head 1 preferably includes multiple strings, however a single string will be effective. Each trimming string 2 is retained in place by the string head 1 by a means of a jaw (not shown) which is found in the string head and which allows for replacement of the strings when needed. The jaw allows for easy insertion of the string into the string head, but locks when the string is moved outward from the string head. The string head 1 is fixed to a rotating power shaft with a head assembly retaining bolt 6 and a string head mounting plate 5, as seen in FIG. 3. The string head mounting plate 5 is fixed to the high lift blade 4, preferably by bolts 12. Also shown in FIGS. 2 and 3 are the drum retaining block 7 and retaining block clamp bolt 9. The rotating housing 3 rotates on top of the drum retaining block 7 which is more clearly seen in FIG. 3.

FIG. 3 is a side view cross section of the cutting assembly in combination with the rotating housing. In this view, the rotating housing 3 is seen in a cross section view surrounded by the bumper 14. The rotating housing 3 is fixed to the top of the drum retaining block 7 which is clamped to a bearing housing 8 by the retaining block clamp bolt 18. Pressed within the bearing housing 8 are ball bearings 9. The bearings 9 retain and seat the rotating shaft 11 one end of which is attached to trimmer pulley 16. The retaining bolt 6 extends through the hollow shaft and secures the blade 4, the string head 1, and the trimmer pulley 16 to the hollow shaft 11. The retaining bolt 6 is secured at the top of the pulley 16 by nut 17. In this example of a mower deck mounted configuration, the pulley 16 and shaft 11 are driven by drive belt 15. At the bottom of the rotating shaft 11 is the string head 1 which accommodates the trimming line 2. The high lift blade 4 is engaged with the string head 1 by means of the head mounting plate 5 and is secured by head mounting bolts 12. When spinning, the high lift blade 4 acts as an impeller creating a suction of air into the trimmer housing. The curved corners of the trimmer housing 3 directs the air and any grass clippings inward where they are then re-cut by the blade. The sail 25 of the cutting blade 4 affects the level of suction into the housing 3. A high sail 25 will provide a high level of suction and a lower sail 25 will provide a lesser amount of suction.

In the preferred embodiment the string head 1 is positioned directly below the cutting blade 4, and in operation, the string 2 is in movement directly below the housing 3. In a preferred embodiment, as shown in FIG. 3, the string 2 extends beyond the bottom lip 26 of the housing 3. As the line 2 wears, the suction created by the sail 25 will pull grass and weeds toward and into the housing 3, thus allowing for longer periods of efficient operation and less down time lost replacing string, thus using less string than normal.

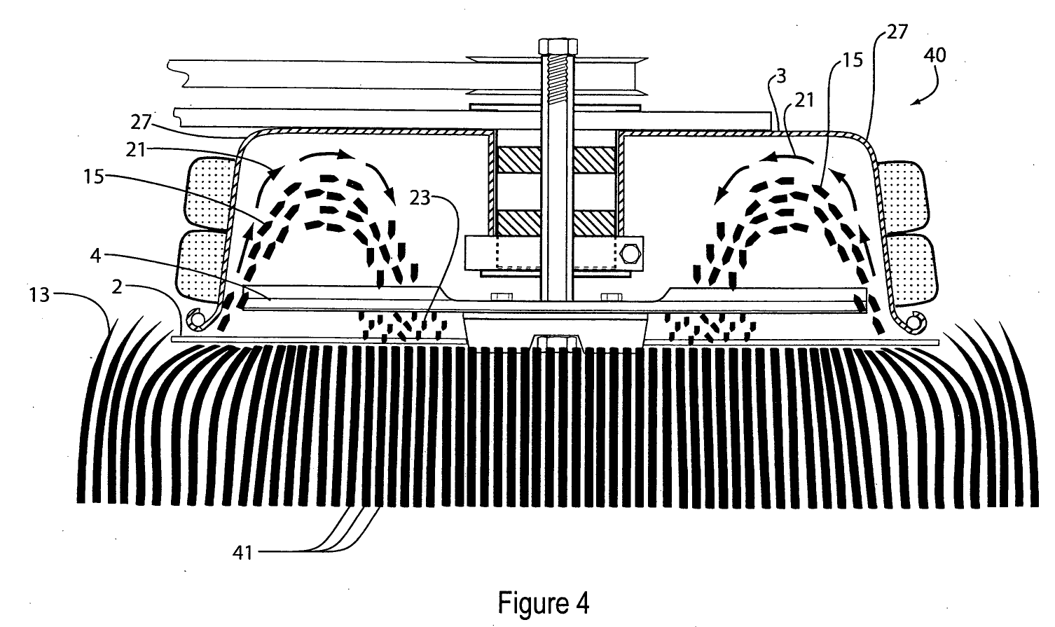

Similar to FIG. 3, FIG. 4 is a cross sectional view of the entire cutting assembly 40 showing the directional air flow created by the rotating high lift blade 4. The rotating high lift blade 2 creates an inward flow of air around the lip 26 of the assembly 40. Uncut blades of grass or weeds to be trimmed 13 are drawn near to the assembly where they are first cut by the trimming line 2. Once the grass is cut, the grass trimmings 15 are first drawn upward above the blade and into the housing 3 following a directional air flow stream indicated in the drawing by arrows 21. The rounded top corners 27 of the housing 3 create an air flow that first lifts the clippings 15 upward and then back downward nearer the center of the blade 4. As the clippings follow the air stream downward they are re-cut into smaller clippings 23 before being redeposited onto the cut lawn surface 41. By creating this inward air flow, not only are the grass and weeds pulled away from obstructions for closer trimming, but the clippings are also cut finer due to the double cutting action that occurs by utilizing both the trimming string and blade.

This description of the preferred embodiment is intended to be illustrative in and is not intended to be limiting upon the scope and contest of the following claims.

1-6. (canceled)

7. An improved cutting assembly for cutting vegetation comprising in combination:
a. a housing defining an interior cavity having a vertical centerline and a horizontally oriented bottom opening said housing further having an outwardly curved bottom lip and defining a rounded top corner joining a generally vertical side wall and a generally horizontal top wall;
b. a driveshaft positioned within the housing at the centerline;
c. a first cutting element defining a sail fixed to the drive shaft and positioned within the housing;
d. a second cutting element fixed to the shaft below the first cutting element, and positioned immediately below the horizontal bottom opening; and
e. a power source engaged with the drive shaft for imparting rotational movement to the drive shaft thereby causing the first cutting element and second cutting element to rotate, thereby creating a cutting action; wherein the rounded top corner of the housing and the sail of the first cutting element acting as an impeller when rotating creates a vortex of air movement within the housing; thereby creating a suctioning flow of air past the curved bottom lip through the bottom opening into the interior cavity of the housing thereby drawing vegetation to be cut into the housing from outside the curved bottom lip of the housing.

8. The cutting assembly of claim 7 wherein the rounded top corner of the housing works in combination with the sail of the first cutting element to enhance the suctioning flow of air from around the outside of the curved bottom lip into the housing interior cavity, wherein the suctioning flow of air creates a vortex, drawing vegetation into the housing interior cavity from outside the curved lip, wherein the vegetation is cut by the second cutting element and the resultant clippings are drawn further into the interior cavity where they are recut by the first cutting element before they drop out of the interior cavity to the ground.

9. The cutting assembly of claim 7 wherein the housing is designed to rotate around the vertical centerline as the housing comes into contact with obstacles during the cutting operation, and the suctioning flow of air from around the outside of the curved bottom lip draws vegetation away from such obstacles and into the interior cavity of the housing.

10. The cutting assembly of claim 8 wherein the second cutting element comprises at least one flexible line.

11. The cutting assembly of claim 10 wherein the at least one flexible line extends horizontally beyond the perimeter defined by the curved bottom lip of the housing.
